(19) United States
(12) Patent Application Publication
(10) Pub. No.: US 2009/0276521 A1
(43) Pub. Date: Nov. 5, 2009

(54) JUDICIAL MONITORING ON PEER-TO-PEER NETWORKS

(75) Inventor: Mohammad Vizaei, Wien (AT)

Correspondence Address: K&L Gates LLP, P.O. BOX 1135, CHICAGO, IL, 60690, US

(73) Assignee: Nokia Siemens Networks GmbH & Co. KG, München (DE)

(21) Appl. No.: 12/297,932

(22) PCT Filed: Apr. 18, 2007
(86) PCT No.: PCT/EP2007/053780

§ 371 Date: Feb. 27, 2009

(30) Foreign Application Priority Data
Apr. 21, 2006 (EP) 06112877.3

(51) Int. Cl. G06F 15/173

(52) U.S. Cl. 709/224

(57) ABSTRACT

The invention relates to a procedure for judicial monitoring in peer-to-peer networks, in which participants to be monitored are marked, and in which furthermore upon setting up a peer-to-peer communication with a marked participant the connection is diverted via a monitoring server and access to the communication data takes place with an appropriate monitoring server service. This realizes the requirement for judicial monitoring in a simple way.

### TECHNICAL FIELD

The invention relates to a method for the judicial monitoring on peer-to-peer networks.

PRIOR ART

Peer-to-peer networks are networks without central access control, in which all participants (peers) act with equal authorization. In contrast to client-server systems, a connection exists here directly between two participants without interposition of a network server. Dispensing with central servers leads to a reduction in the data traffic in the network, enables large volumes of data to be stored decentralized in a simple manner and increases the fault tolerance of the network. Apart from the high demands on the performance of the terminals, the lack of capability of monitoring any communication based thereon is often also seen as being disadvantageous in peer-to-peer networks.

This monitoring, i.e. the listening to telephone calls or also reading e-mails, short messages (so-called SMS), faxes, etc. on the basis of legal regulations and/or decrees is a demand made by many states on the operators of communication networks. Usually, this is intended to prevent punishable acts on the basis of a judicial decision.

An English technical term, Lawful Interception (LI), designates a security process in this context. By means of this process, an operator of a telecommunication network or a provider of telecommunication services (e.g. Internet provider, IP telephony provider, etc.) provides a public office or authority authorized for monitoring (e.g. police, customs etc.), generally also called law enforcement agency (LEA), with access to telecommunication processes and contents (e.g. telephone calls, e-mail or fax communication, connection-related data such as, e.g. directory number dialed, directory number of an incoming call, etc.) of a particular participant.

For this purpose, a so-called lawful interception interface for transmitting data between the telecommunication network operator or telecommunication services provider and the monitoring office or authority is set up in the telecommunication network. Via this lawful interception interface, for example, data—such as e.g. call contents, fax data, connection-related data, contents of e-mails or short messages—are then in a monitoring case transmitted mostly in real time from the telecommunication network to a monitoring device of the legally authorized office or authority.

To implement lawful interception in a simpler manner and also to provide for a cross-boundary—e.g. pan-european monitoring of telecommunication processes and contents, standards and technical specifications have been developed for lawful interception and corresponding interfaces—such as, e.g. ES 201 671 Telecommunications Security; Lawful Interception (LI); Handover Interface for Lawful Interception of Telecommunications Traffic; TS 101 232 Telecommunications Security; Lawful Interception (LI); Handover Specification for IP delivery, etc., which have been published by the Technical Committee on Lawful Interception (TC LI) of the European Telecommunications Standard Institute (ETSI). These standards and technical specifications for lawful interception published by ETSI are mainly used in Europe, in large parts of Asia and partially also in Australia. These standards describe not only in great detail the architecture of a system and the interfaces for lawful interception but also telecommunication network-specific protocol requirements and procedures which are necessary for transmitting data of the telecommunication processes of a monitored participant from the telecommunication network operator or provider of telecommunication services to the office or authority legally empowered for the monitoring.

In the USA, basics for lawful interception are defined in the so-called Communications Assistance for Law Enforcement Act (CALEA) and supplemented by publications of various committees of the Alliance for Telecommunications Industry Solutions (ATIS)—such as PTSC LAES (Packet Technologies and Systems Committee Lawfully Authorized Electronic Surveillance) or WTSC LI (Wireless Technologies and Systems Committee Lawful Intercept)—for various telecommunication network types such as, e.g. mobile radio networks, IP-based networks etc.

### DESCRIPTION OF THE INVENTION

The invention is based on the object of specifying a method by means of which judicial monitoring can be implemented on peer-to-peer networks.

According to the invention, this is done by means of a method of the type initially mentioned in which participants to be monitored are marked, in which, furthermore during the setting-up of a peer-to-peer communication with a marked participant, the connection is diverted via a monitoring server and in which the access to the communication data takes place with a suitable service of the monitoring server.

In this arrangement, the type and manner of marking the participant depends on the architecture of the network. In the case of a centralized architecture of the peer-to-peer network, in which one or more servers are responsible for the search for data, the participant is marked advantageously in the search servers.

In decentralized peer-to-peer networks, in which any centralized facilities are dispensed with and there is no hierarchy in the network whatsoever, the marking suitably takes place in the application software of each participant himself.

In the so-called super peer-to-peer networks, the super-peers are available for administering the marking for the monitoring.

### BRIEF DESCRIPTION OF THE DRAWING

The invention will be explained in greater detail with reference to two figures which by way of example show the sequence of a message exchange according to the invention for the judicial monitoring in a diagrammatically shown peer-to-peer network.

### EXECUTION OF THE INVENTION

The peer-to-peer network shown diagrammatically in the figures comprises a first participant A and a second participant B and a monitoring server MID server. In the present example, the communication of the second participant B is to be monitored on the basis of a judicial order.

For this purpose, the second participant is marked with suitable means, i.e. his data are correspondingly supplemented in the distributed peer-to-peer database.

In this context, it is of no significance to the essence of the invention which actual network structure is used.

In the case of a centralized (hybrid) architecture of the peer-to-peer network, in which one or more servers are responsible for the search for data, the participant can thus be marked in the search servers.

In the second category of peer-to-peer networks, the decentralized (pure) peer-to-peer networks in which any centralized facilities are dispensed with and there is no hierarchy in the network whatsoever, the marking takes place in the application software of each participant himself.

The third category of peer-to-peer network architectures, the so-called super-peer-to-peer networks represents a mixed form of the other two network forms. In this architecture, so-called super-peers form clusters with connected clients, the super-peer administering meta-information about the connected clients. In this architecture, the super-peer is available as responsible means for marking for the monitoring.

During the exemplary setting-up of a data connection to a second participant B marked in this manner, the marking stored in accordance with the network architecture is thus recognized during the setting-up of the connection between the calling first participant A and the called second participant B to be monitored and the data connection is thereupon set up, not directly between the two participants A, B as is common practice in peer-to-peer networks, but diverted via a monitoring server MID server.

The monitoring server MID server then contains the means for providing a monitoring interface, for example according to ES 201 671 Telecommunications Security; Lawful Interception (LI); Handover Interface for Lawful Interception of Telecommunications Traffic; TS 101 232 Telecommunications Security; Lawful Interception (LI); Handover Specification for IP delivery, etc. which have been published by the Technical Committee on Lawful Interception (TC LI) of the European Telecommunications Standards Institute (ETSI).

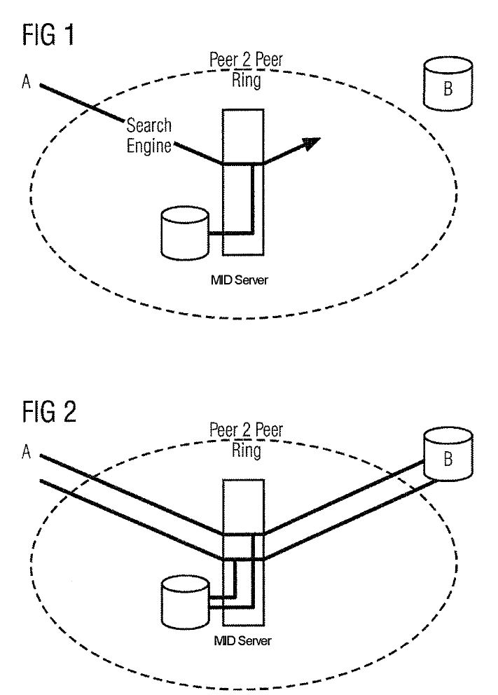

FIG. 2 shows diagrammatically the situation after the setting-up of the connection during the communication process, that is to say, for example, a telephone call, a chat etc.

In this context, the complete dataflow occurs via the monitoring server MID server so that the data can be correspondingly monitored via the monitoring interface.

1. A method for the judicial monitoring on peer-to-peer networks, characterized in that participants to be monitored are marked, that furthermore during the setting-up of a peer-to-peer communication with a marked participant, the connection is diverted via a monitoring server and in that the access to the communication data takes place with a suitable service of the monitoring server.

2. The method as claimed in claim 1, characterized in that in the case of a centralized architecture of the peer-to-peer network, in which one or more servers are responsible for the search for data, the participant is marked in the search servers.

3. The method as claimed in claim 1, characterized in that in the case of decentralized peer-to-peer networks in which any centralized facilities are dispensed with and there is no hierarchy in the network whatsoever, the marking takes place in the application software of each participant himself.

4. The method as claimed in claim 1, characterized in that in the case of super peer-to-peer networks, the super-peers administer the marking for the monitoring.
